(19) United States
(12) Patent Application Publication
(10) Pub. No.: US 2026/0245041 A1
(43) Pub. Date: Aug. 20, 2026

(54) GRAPH NEURAL NETWORK AND TRANSFORMER-BASED TASK PLANNER

(71) Applicant: IUCF-HYU (Industry-University Cooperation Foundation Hanyang University), Seoul (KR)

(72) Inventors: Yoonseon OH, Seoul (KR); Soojin JEONG, Seoul (KR); Seongwan BYEON, Seoul (KR)

(73) Assignee: IUCF-HYU (Industry-University Cooperation Foundation Hanyang University), Seoul (KR)

(21) Appl. No.: 19/540,411

(22) Filed: Feb. 13, 2026

(30) Foreign Application Priority Data
Feb. 20, 2025 (KR) 10-2025-0022214

(51) Int. Cl. G06Q 10/10; G06N 3/08; G06Q 10/0631

(52) U.S. Cl. CPC G06Q 10/10; G06N 3/08; G06Q 10/06316

(57) ABSTRACT

Disclosed is a graph neural network (GNN) and transformer-based task planner. A task planning method performed by a task planning system may include constructing a task planner model based on a graph neural network and a transformer; and generating a task plan from a goal instruction of a task and history information of a scene graph through the constructed task planner model.

### CROSS-REFERENCE TO RELATED APPLICATION(S)

This application claims the priority benefit of Korean Patent Application No. 10-2025-0022214, filed on Feb. 20, 2025, in the Korean Intellectual Property Office, the disclosure of which is hereby incorporated by reference.

### BACKGROUND

### 1. Field of the Invention

The following description relates to technology for planning a task of a robot.

### 2. Description of the Related Art

Natural language is the most intuitive method for humans to interact with robots, making task planning based on natural language instructions a longstanding area of research. Traditionally, a task sequence planner may be created by combining a neural network-based learning with Planning Domain Definition Language (PDDL), a traditional task planning language, which may only establish an action plan according to predefined rules, and shows a degradation in performance and a limitation in model scalability in an environment other than a limited domain.

To overcome these issues, large language models (LLMs) have significantly improved task planning by enhancing the ability to understand a natural language and common sense. However, current methods lack the deep understanding of physical environments, their performance relies heavily on prompt examples, and LLMs are oversized and not customized for specific tasks, and planning cost remains high.

### SUMMARY

Example embodiments provide a task planner model that combines a graph neural network for sufficiently learning data related to a task sequence and a goal instruction from graph-based environmental information and a transformer that considers understanding of the task sequence and instruction.

Example embodiments may generate a task plan from a goal instruction of a task and history information of a scene graph through a task planner model.

According to an aspect, there is provided a task planning method performed by a task planning system, the task planning method including constructing a task planner model based on a graph neural network and a transformer; and generating a task plan from a goal instruction of a task and history information of a scene graph through the constructed task planner model.

The generating may include transforming a node and an edge constituting the scene graph to a node feature and an edge feature, respectively, through a scene graph encoder.

The generating may include extracting an instruction feature that includes a sentence embedding and a token embedding from the goal instruction through an instruction encoder.

The generating may include planning a subgoal based on context information of an ongoing task, based on history of a state graph encoded through a scene graph encoder and an instruction feature encoded through an instruction encoder in a subgoal planning network, and the subgoal planning network may include a graph feature extractor and a subgoal predictor.

The generating may include extracting a task-relevant feature from the history of the encoded state graph and the goal instruction using an edge update function, a node update function, and a global update function in a GNN layer stack.

The edge update function may update edge information by combining an edge that concatenates an i^{th} node and a j^{th} node and a sentence embedding and then passing through a multi-layer perceptron (MLP) function, the node update function may update node information based on an i^{th} node feature and an edge feature and a sentence embedding with neighboring nodes updated from a previous edge update function, and the global update function may update a node feature and a sentence embedding.

The generating may include updating graph information using a node feature and a sentence embedding updated through cross-attention to emphasize a feature of an object having high goal relevance, and outputting a graph token from an initial time to a current time step through the updated graph information.

The generating may include generating a state token for the output graph token and token embedding through cross-attention to emphasize a word having the highest relevance from an instruction in the current time step.

The generating may include selecting a subgoal that includes action information and a target object in a next time step from the generated state token and the updated node feature.

The generating may include generating a task token that encodes history information of an ongoing task through element-wise addition of the generated state token and a positional embedding in a task encoder, and generating a next action probability distribution and a next target object action distribution in a next time step from the generated state token and the updated node feature through an action decoder and an object decoder.

The generating may include determining a feasible subgoal with the highest probability based on the generated next action probability distribution and next target object action distribution.

The generating may include determining the feasibility of the selected subgoal that includes action information and the target object in the next time step according to a predefined rule for each action.

A node dropout method in which a specific object and background objects are categorized from an initial graph and a ground truth task plan may be applied in a learning process of the task planner model.

According to an aspect, there is provided a non-transitory computer-readable recording medium storing a computer program to execute a task planning method performed by a task planning system, wherein the task planning method includes constructing a task planner model based on a graph neural network and a transformer; and generating a task plan from a goal instruction of a task and history information of a scene graph through the constructed task planner model.

According to an aspect, there is provided a task planning system including a model construction unit configured to construct a task planner model based on a graph neural network and a transformer; and a task plan generation unit configured to generate a task plan from a goal instruction of a task and history information of a scene graph through the constructed task planner model.

According to some example embodiments, it is possible to not only understand the task history through graph-based state representation through a graph neural network and generate sequential task planning using a goal instruction, but also improve the performance of task planning prediction through a transformer that is excellent in learning sequences such as history.

According to some example embodiments, by adjusting a graph size through node dropout to cope with graphs of various sizes, a task planner model may independently learn the change in background objects and may exhibit the generalization capability of adapting to the environmental change according to the number of objects.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates the general operation of generating task planning according to an example embodiment;

FIG. 2 illustrates a task planner model according to an example embodiment;

FIG. 3 illustrates a data augmentation operation according to an example embodiment;

FIG. 4 is a block diagram illustrating a task planning system according to an example embodiment;

FIG. 5 is a flowchart illustrating a task planning method according to an example embodiment; and

FIGS. 6 and 7 illustrate the technical effect of a task planner model according to an example embodiment.

### DETAILED DESCRIPTION

Hereinafter, example embodiments will be described in detail with reference to the accompanying drawings.

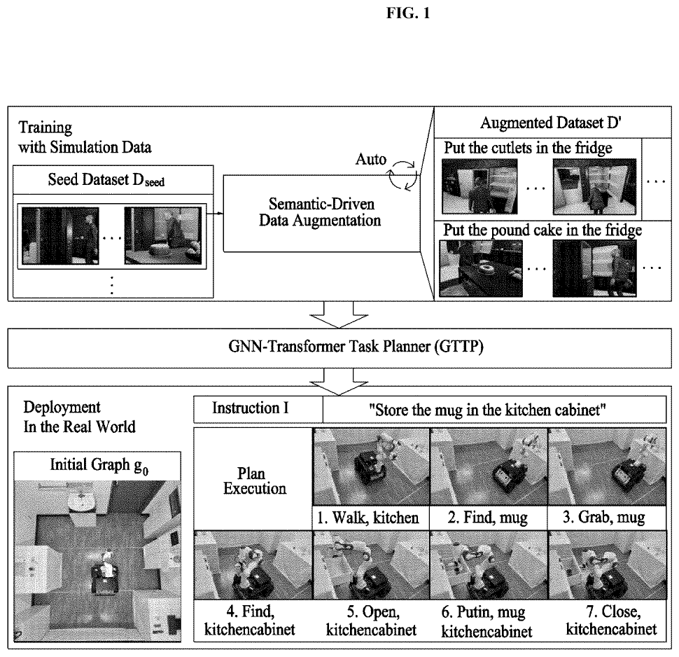

FIG. 1 illustrates the general operation of generating task planning according to an example embodiment.

The top of FIG. 1 shows an automatic data augmentation procedure using a small seed dataset based on semantic information of a task in a simulation environment. A task planning system may train a task planner (GNN-Transformer Task Planner (GTTP)) model using an augmented dataset. Here, the task planner model may be configured based on a graph neural network (GNN) and a transformer model. The bottom of FIG. 1 shows an inference procedure of generating a task plan using a goal instruction of a task and an initial scene graph through the trained task planner model. The task planner model may extract feature information of an object important for a task from a state graph and an instruction through the graph neural network. The task planner model may generate a task plan that considers information of previous states through a transformer structure. The task planner model may determine the feasibility of a predicted next plan and a plan completion time.

The task planner model may receive a scene graph that integrates semantic information on an encoded object through a text embedding module. Here, the semantic information is processed by the graph neural network to accommodate various numbers of objects, and is combined with the transformer model to consider past states. The task planner model may select a feasible high-level plan for execution.

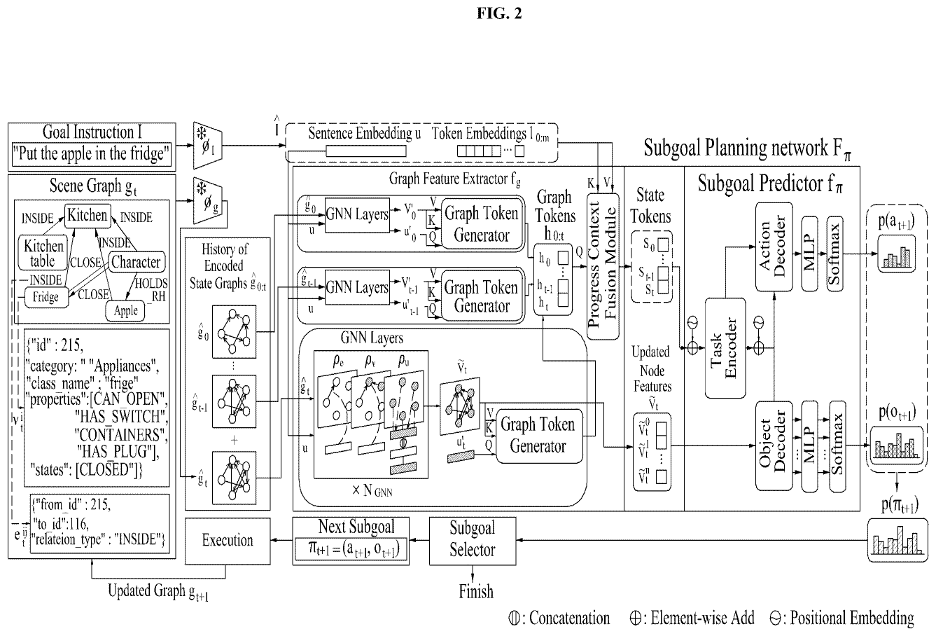

FIG. 2 illustrates a task planner model according to an example embodiment.

The example embodiment proposes a high-level robot task planning method based on natural language instructions. For convenience of description, household tasks in a complex environment are described as an example in FIG. 2. For example, when an agent receives a goal instruction “Put the chicken in the microwave,” the agent needs to walk to the kitchen, find and grab the chicken, open the microwave, and place the chicken inside. As such, the example embodiment aims to generate a high-level and interpretable subgoal.

Formally, a goal instruction may be represented by I. The state of an environment and a robot may be represented by a directed scene graph gₜ=(νₜ,εₜ) at time t. Here, νₜ and εₜ denote node and edge features, respectively. Each node vₜⁱνₜ may contain five types of knowledge including a unique identifier, a class name, a category, a property, and a state.

The unique identifier (id) represents a unique value that is assigned to each object to distinguish each object from other objects within a graph by assigning a unique value to each object.

The class name denotes a specific name of an object (e.g., apple).

The category represents a broader classification group, such as appliances.

The property describes the attribute of an object.

The state represents a current state of an object.

A directed edge

$${e}_{t}^{ij} ∈ {ε}_{t}$$

represents a semantic relation between

$${v}_{t}^{i} and {v}_{t}^{j} .$$

The subgoal at time t is expressed as πₜ=(aₜ, oₜ). Here, aₜ∈ [symbol] and oₜ∈ [symbol] represent a robot action skill and a target object to which the robot action skill is to be applied, respectively. Here, an action skill set may be defined as A={Walk, Find, Open, Close, Grab, PutIn, PutBack, SwitchOn, SwitchOff, Finish}. An object set [symbol] is a set of all objects within a given environment, which is assumed to be fully observable. In an example embodiment, a task planner model for predicting an appropriate subgoal may be designed based on the goal instruction I and state graph history g_{0:t}={g₀, . . . ,gₜ₋₁,gₜ}. The output of the task planner model at time t is a subgoal πₜ₊₁ to be performed at next time t+1.

A task planning process of the task planner model is described with reference to FIG. 2. A scene graph encoder φ_{g} and an instruction encoder φ_{I} may extract features from an environment and a natural language instruction, respectively. A subgoal planning network may predict the probability of action p(aₜ₊₁) and object p(oₜ₊₁) for next time step t+1 based on the history of encoded state graph ĝ_{0:t} and the encoded instruction Î. A subgoal selector may determine a feasible subgoal with the highest probability. This task planning process may be repeated until task completion is achieved.

To address an instruction-driven high-level task planning issue, the task planner model may be configured based on a transformer model and a graph neural network having the goal instruction I and the state graph history g_{0:t} as input. Here, the goal instruction I and the scene graph gₜ may be encoded by the instruction encoder φ_{I} and the scene graph encoder φ_{g}, respectively. Subsequently, the encoded goal instruction and scene graph may be input to the subgoal planning network [symbol] _{π} along with the history of a previous state graph, to estimate the probability distribution of potential subgoals based on the context of ongoing task sequence. Therefore, the subgoal selector may select a feasible subgoal πₜ₊₁ with the highest probability.

More specifically, each node

$${v}_{t}^{i}$$

and edge

$${e}_{t}^{ij}$$

in the scene graph gₜ may include semantic information on the environment in JSON format as shown in FIG. 2. The scene graph encoder φ_{g} may leverage text embedding models to transform the node vₜⁱ and the edge

$${e}_{t}^{ij}$$

to 384-dimensional vectors, termed node feature

$${\hat{v}}_{t}^{i}$$

and edge feature

$${\hat{e}}_{t}^{ij} ,$$

respectively. The embedded scene graph ĝₜ may preserve the original graph structure, maintaining semantic information between objects.

The instruction encoder π_{I} may generate an instruction feature Î including a sentence embedding u and a token embedding set l_{0:m} form from instruction sentence I. Here, m denotes the number of tokens. In an example embodiment, Sentence-BERT may be adopted for both the scene graph encoder φ_{g} and a goal encoder φ_{I} to share the same latent space.

The subgoal planning network may process the history of the encoded state graph ĝ_{0:t} and the encoded instruction feature Î to plan a subgoal πₜ₊₁. The subgoal planning network may include a graph feature extractor f_{g} and a subgoal predictor f_{π}.

The graph feature extractor may be configured to extract a state token that includes state information and a node feature that includes object information by combining the embedded scene graph and the sentence embedding u. The graph feature extractor may interpret both the encoded scene graph and the encoded instruction using GNN layers, a graph token generator, and a progress context fusion module. The graph feature extractor may use a GNN layer stack to extract task-relevant features from the history of the encoded state graph ĝ_{0:t} and the sentence embedding u. The graph feature extractor may design GNN layers using three update functions, ρₑ, ρ_{ν}, and ρᵤ.

The edge update function ρₑ may update edge information by combining the edge that concatenates an i^{th} node and a j^{th} node and a sentence embedding and then passing through a multi-layer perceptron (MLP) function. Then, the node update function ρ_{ν} may update node information based on an i^{th} node feature and an edge feature and a sentence embedding with neighboring nodes updated from a previous edge update function. Finally, the global update function ρᵤ may update a node feature and a sentence embedding.

The edge update function ρₑ may be formulated as follows.

$${\tilde{e}}_{t}^{ij} = {ρ}_{e} ( {\hat{v}}_{t}^{i} , {\hat{v}}_{t}^{j} , {\hat{e}}_{t}^{ij} , u ) = g ( {\hat{v}}_{t}^{i} ‖ {\hat{v}}_{t}^{j} ‖ {\hat{e}}_{t}^{ij} ‖ u )$$

Here, g(⋅) denotes the MLP function and ∥ denotes vector concatenation. Each updated edge

$${\hat{e}}_{t}^{ij}$$

may aggregate information from the connected node and the provided sentence embedding u.

Likewise, the node feature

$${\tilde{v}}_{t}^{i}$$

may be updated by the node update function ρ_{ν}.

$${\tilde{v}}_{t}^{i} = {ρ}_{v} ( {\hat{v}}_{t}^{i} , {𝒩}_{t}^{i} , u ) = g ( {\hat{v}}_{t}^{i} ‖ \frac{1}{\vert {𝒩}_{t}^{i} \vert} {\sum }_{k ∈ {𝒩}_{t}^{i}} g ( {\hat{v}}_{t}^{k} \vert \vert {\tilde{e}}_{t}^{ki} ) ‖ u )$$

Here,

$${𝒩}_{t}^{i}$$

denotes a set of neighbor nodes of

$${v}_{t}^{i} .$$

The updated node

$${\tilde{v}}_{t}^{i}$$

may include surrounding environment information.

At last, the sentence embedding u may be inserted as a global feature of a graph, and may be updated by simply averaging all the updated nodes.

$${\tilde{u}}_{t} = {ρ}_{u} ( {\tilde{V}}_{t} , u ) = g ( u ‖ \frac{1}{\vert {\tilde{V}}_{t} \vert} {\sum }_{i ∈ {\tilde{V}}_{t}} {\tilde{v}}_{t}^{i} )$$

Here, V̅ₜ denotes a set of updated node embeddings. In an example embodiment, the number of GNN layers NGNN may be set as 3, and dimensions of the updated node, edge, and instruction feature may be reduced to 256, 128, and 64, respectively.

The graph feature extractor may pass graph features through GNN layers three times and then, may update graph inforamtion using cross-attention to emphasize features of objects havig high goal relevance. The graph feature extractor may add a cross-attention layer called a graph token generator for each updated graph \tilde{g}ₜ. The graph token generator may use the updated sentence embedding ũₜ as query Q and may use updated node embeddings \tilde{V}ₜ as keys K and values V. A graph token hₜ is output from an initial time to a current time step, resulting in h_{0:t}=[h₀, . . . , hₜ]. Also, the agent needs to know which goal condition needs to be resolved for each state. For example, in an instruction “Go to the living room and turn the light off,” “the living room” needs to be emphasized in an earlier state, and “the light” needs to be focused in a later state within the state history. For this reason, the progress context fusion module may apply cross-attention that uses the graph token hot as query and token embeddings l_{0:m} as keys and values. As a result, state tokens from the initial time to the current time step containing instructions and implicit information of the scene graph may be acquired from the graph feature extractor. The resultant state tokens s_{0:t} emphasize important instruction tokens for each state. Therefore, the task planner determines an appropriate subgoal in consideration of the progress context.

The subgoal predictor may select a subgoal containing information of a most appropriate action and a target object from historical state tokens and node embeddings updated by passing through GNN layers. The subgoal predictor may interpret historical state information to generate probability distributions, p(aₜ₊₁) and p(oₜ₊₁), for a next action and a next target object, respectively. The overall structure may be a modified version of vanilla transformer architecture. Initially, a task encoder uses a sequence of state tokens along with positional embeddings to generate task tokens that encode historical information of an ongoing task. These task tokens, through element-wise addition for state tokens and positional embeddings, may be input to both a task decoder and an object decoder to provide sequential history features. The task decoder may take state tokens and may output the task probability for each input state through MLP and softmax layer. In inference, the task planner may use only the probability p(aₜ₊₁) from the current state token St. The object decoder may use the updated node embeddings \tilde{ν}ₜ to find an important target object among them.

To predict a next subgoal, the subgoal selector may determine the probability of the next subgoal that includes an action and a target object, with the highest probability in the next time step, from a previous subgoal predictor. The subgoal selector may determine the next subgoal based on the following equation.

$${π}_{t + 1} = arg {max}_{π ∈ {\prod }_{f}} p ( {π}_{t + 1} ) .$$

Here, Π_{f} denotes a set of subgoals successfully executable in a current state. In simulations, the feasibility of each subgoal may be verified using a specific simulator (e.g., VirtualHome). The subgoal selector may determine the feasibility of a subgoal executed by the agent according to predefined rules for each action. For example, a predefined rule may be set, ‘The agent should not be holding any object to perform a grab action.’ When the subgoal selector determines that the subgoal is executable, that is, when the next subgoal πₜ₊₁ is determined, the state may be updated to gₜ₊₁. Therefore, this process may be iteratively repeated in a single scenario until the predicted next action aₜ₊₁ is completed or until a feasible action may not be found.

Node dropout and a loss function are described. The task planning system may introduce a node dropout method to cope with graphs of various sizes in a learning process of a task planner. The task planning system may categorize an important object and background objects from an initial graph and a ground truth task plan. Starting with the initial scene graph g₀ and the ground truth task plan, the task planning system may classify objects in g₀, [symbol] , into essential objects related to the plan, [symbol] ₑ, and a set of background objects, [symbol] _{b}. By randomly dropping out 30%, 60%, and 90% of [symbol] _{b}, node-dropped graph sequences may be added to a training set, which may improve the robustness of the task planner against the change in background objects. For training, cross-entropy may be used as the loss function by the task planner as follows.

$${ℒ}_{total} = {αℒ}_{action} + {βℒ}_{object}$$

Here, α and β denote coefficients of the loss function. L_{action} and L_{object} denote loss functions related to an action and an object, respectively.

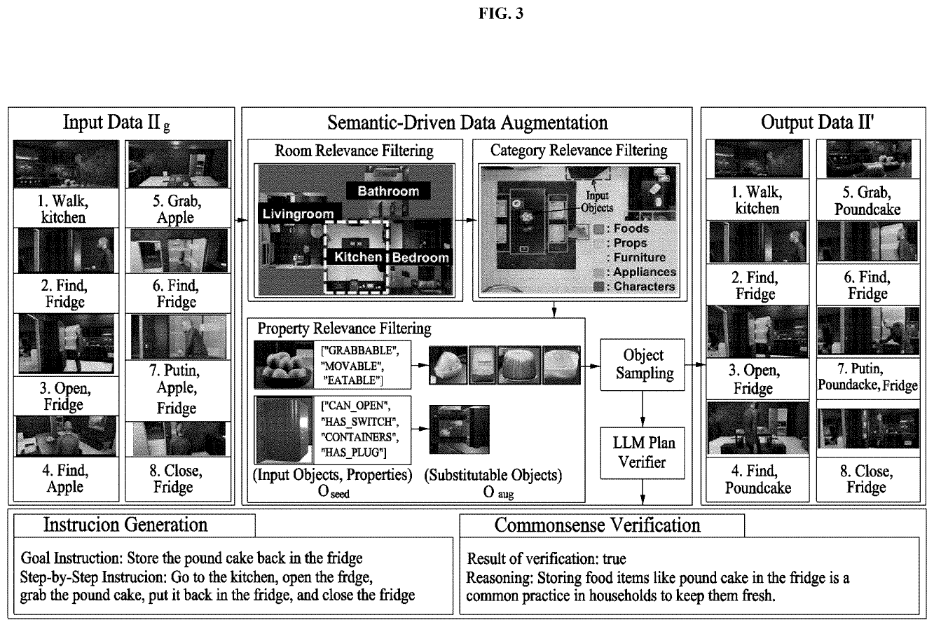

FIG. 3 illustrates a data augmentation operation according to an example embodiment.

The task planning system may propose an automated data augmentation pipeline in consideration of semantic information of objects to augment a seed dataset that is a small hand-crafted task dataset. Also, the task planning system may propose a large language model (LLM)-based automatic plan verification and instruction generation method that not only generates language instructions appropriate for augmented task plans but also evaluates reasonableness of the plans through commonsense reasoning. The seed dataset is denoted by

$${D}_{seed} = \{ ( {\prod }_{g}^{i} , {g}_{0}^{i} ) \vert i = 1 , 2 , … , N \} .$$

Here, Π_{g}ⁱ denotes a sequence of subgoals, and g_{O}ⁱ denotes an initial scene graph of an i^{th} data point. The task planning system may collect a plurality of (e.g., seven) seed tasks from a specific dataset and a plurality of (e.g., six) seed tasks from its own task dataset. The task planning system may acquire an additional seed task by combining or diving them. As a result, the seed dataset may be constructed with N=45.

FIG. 3 shows an automated semantic augmentation process in which an input task is “Put the apple in the fridge,” and a newly generated task is “Store the pound cake in the fridge.” Assuming that task planning data to put the apple in the fridge is input, the task planning system may have a task planning sequence with a subgoal in the form of [action]<object>, such as [walk]<kitchen> . . . [grab]<apple> . . . [close]<fridge>, as data. The task planning system may identify a room in which the task occurred, category and property of an object related to the task from the task planning data, and may perform sampling for an identically replaceable object. For example, the object related to the task may be an apple, and an object that may replace the apple may be pound cake having the same category of foods and the property of “GRABBABLE,” “MOVABLE,” and “EATABLE” in the kitchen of the same room.

To scale up the seed dataset, the task planning system may initially select a data point Π_{g}={π₁, . . . , π_{T}}. Here, T denotes the length of the plan, and πₜ=(aₜ, oₜ). Let a set of all objects within Π_{g} be

$${O}_{seed} = \{ {o}^{′} \vert {π}_{t} = ( {a}_{t} , {o}_{t} ) , {π}_{t} ∈ {\prod }_{g} \} := \{ {o}_{1}^{s} , … , {o}_{n}^{s} \} .$$

Here, n denotes the number of unique objects in Π_{g}. Any object o^{g}∈O_{seed} may be replaced with another object in consideration of semantic information, such as a location, category, and property. Replacement may be allowed only when a substitute object is located in the same room and shares the identical category and property with o^{s}. This potential replacement object set may be denoted as O_{aug}(o^{s}) This approach maintains contextual relevance and consistency with original data point characteristics in augmented data. Then, a set of objects O′={o₁′, . . . ,oₙ′} may be sampled, and each oᵢ′ may be sampled from O_{aug}(oᵢ^{s}). The total number of distinct sampling combinations may be represented as Πᵢ₌₁ⁿ O_{aug}(oᵢ^{s})|. The task planning system may generate a new plan Π′ by sampling O′ and then replacing each

$${o}_{i}^{s} of {\prod }_{g} with {o}_{i}^{′} .$$

More formally, the revised plan is

$${\prod }^{′} = \{ {π}_{1}^{′} , … , {π}_{T}^{′} \} .$$

### Here, if

$${o}_{t} = {o}_{k}^{s} , {π}_{t}^{′} = ( {a}_{t} , {o}_{k}^{′} ) .$$

The sampling process may be repeated for Nₛₐₘₚₗₑ. In an example embodiment,

$${N}_{sample} = min ( {\prod }_{i = 1}^{n} \vert {O}_{avg} ( {o}_{t}^{s} ) \vert , 20 )$$

may be set in 50 different types of environments.

The task planning system may propose an LLM plan verifier, a module that generates natural language instructions to explain an augmented task plan and to verify whether the plan is suitable for everyday household robotic tasks. For example, as shown in FIG. 3, the given task plan is annotated in two formats, a goal instruction, “Store the pound cake back in the fridge,” and a step-by-step instruction, “Go to the kitchen, open the fridge, grab the pound case, put it back in the fridge, and close the fridge.” However, not all augmented plans are practical or typical. For example, the plan verifier may exclude a task annotated as “Microwave chocolate bar” due to the fact that “Microwaving a candy bar is not a typical household task, and could be potentially dangerous if it involves wrappers or ingredients that are unsuitable for microwaving.” Through this, unreasonable data points may be automatically excluded.

The LLM plan verifier may employ a large language model in a few-shot learning method. A prompt designed with a Chain-of-Thought (CoT) method may generate both verification decision and reasoning behind the verification decision. Each prompt may begin with a guidance sentence to summarize and evaluate a robot task plan. This is followed by few-shot examples that include a task plan, its natural language instruction I, and commonsense verification results (true or false). The dataset may include output from the LLM plan verifier only when the plan is verified as true. In an example embodiment, a large language model (e.g., GPT-4O model) configured with a plurality of (e.g., three) few-shot examples may be employed. A total number of 14,000 datasets including various categories, such as object relocation, appliance operation, cooking foods, and object retrieval, may be generated.

Such a large language model may simultaneously output language instructions below along with commonsense reasoning for a task. The task planning system may generate “Store the pound cake in the fridge” as the goal instruction containing implicit information through the LLM plan verifier, and may generate “Go to the kitchen, open the fridge, grab the pound cake, put it back in the fridge, and close the fridge” as the step-by-step instruction containing detailed information. The task planning system may perform reasoning of “Storing food items like pound cake in the fridge is a common practice in households to keep them fresh.” due to the fact that data for the task sequence is valid for commonsense reasoning through commonsense verification, and may classify inference results as data that is determined to be commonsense and usable.

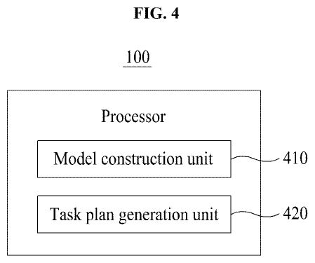

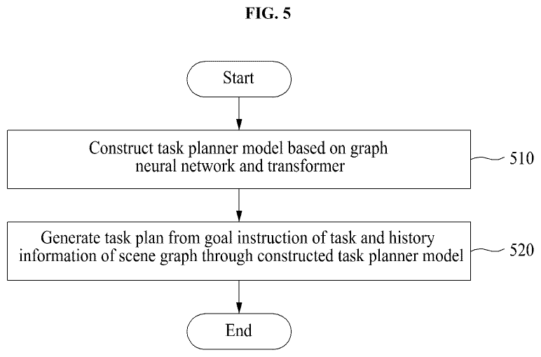

FIG. 4 is a block diagram illustrating a task planning system according to an example embodiment, and FIG. 5 is a flowchart illustrating a task planning method according to an example embodiment.

A processor of a task planning system 100 may include a model construction unit 410 and a task plan generation unit 420. The components of the processor may be representations of different functions performed by the processor in response to a control instruction provided from a program code stored in the task planning system 100. The processor and the components of the processor may control the task planning system 100 to perform operations 510 to 520 included in the task planning method of FIG. 5. The processor and the components of the processor may be implemented to execute an instruction according to a code of at least one program and a code of an operating system (OS) included in a memory.

The processor may load a program code stored in a file of a program for the task planning method to the memory. For example, when the program is executed on the task planning system 100, the processor may control the task planning system 100 to load the program code from the file of the program to the memory under control of the OS. Here, each of the model construction unit 410 and the task plan generation unit 420 may be different functional representations of the processor to perform operations 510 to 520 after executing an instruction of a corresponding portion in the program code loaded to the memory.

In operation 510, the model construction unit 410 may construct a task planner model based on a graph neural network and a transformer. Here, a node dropout method in which a specific object and background objects are categorized from an initial graph and a ground truth task plan may be applied in a learning process of the task planner model.

In operation 520, the task plan generation unit 420 may generate a task plan from a goal instruction of a task and history information of a scene graph through the constructed task planner model. The task plan generation unit 420 may transform a node and an edge constituting the scene graph to a node feature and an edge feature, respectively, through a scene graph encoder. The task plan generation unit 420 may extract an instruction feature that includes a sentence embedding and a token embedding from the goal instruction through an instruction encoder. The task plan generation unit 420 may plan a subgoal based on context information of an ongoing task, based on history of a state graph encoded through a scene graph encoder and an instruction feature encoded through an instruction encoder in a subgoal planning network. The task plan generation unit 420 may extract a task-relevant feature from the history of the encoded state graph and the goal instruction using an edge update function, a node update function, and a global update function in a GNN layer stack. The task plan generation unit 420 may update graph information using a node feature and a sentence embedding updated through cross-attention to emphasize a feature of an object having high goal relevance, and may output a graph token from an initial time to a current time step through the updated graph information. The task plan generation unit 420 may generate a state token for the output graph token and token embedding through cross-attention to emphasize a word having the highest relevance from an instruction in the current time step. The task plan generation unit 420 may select a subgoal that includes action information and a target object in a next time step from the generated state token and the updated node feature. The task plan generation unit 420 may generate a task token that encodes history information of an ongoing task through element-wise addition of the generated state token and a positional embedding in a task encoder, and may generate a next action probability distribution and a next target object action distribution in a next time step from the generated state token and the updated node feature through an action decoder and an object decoder. The task plan generation unit 420 may determine a feasible subgoal with the highest probability based on the generated next action probability distribution and next target object action distribution. The task plan generation unit 420 may determine the feasibility of the selected subgoal that includes action information and the target object in the next time step according to a predefined rule for each action.

FIGS. 6 and 7 illustrate the technical effect of a task planner model according to an example embodiment.

FIG. 6 shows a table of results of comparing the performance between a large language model (LLM)-based task planner and other learning-based task planners. The experiments are conducted in both seen and unseen environments. Here, the seen environment refers to an environment included in a training set, and the unseen environment refers to an environment not included in the training set. The best-performing model is highlighted in bold.

FIG. 7 shows the results of the task planner model (GTTP) proposed in the example embodiment that performed a task plan according to an instruction form in a real-world environment. The experiments may include seven types of tasks, and each may be displayed in two formats that include a goal instruction (G) and a step-by-step instruction. GCR and SR metrics indicate how accurately the task planner (GTTP) predicts subgoals, while Plan SR indicates the metrics when an action task of a robot is successfully performed.

It can be confirmed that the task planner model (GTTP) proposed in the example embodiment generates sequential task planning based on input that includes task history and a goal instruction through graph-based state representation, and exhibits the superior performance compared to other compared task planners. In the seen environment, the proposed task planner model (GTTP) shows an 18.1% higher success rate (SR) than the best-performing other compared task planners. Also, it is demonstrated that the proposed task planner model (GTTP) may better handle complex environments and various instructions in the seen environment, and also maintains robustness of performance even in the unseen environment. In terms of execution feasibility (Exec), the proposed task planner model (GTTP) shows the very high execution feasibility of 99% compared to other comparison models. It can be confirmed that the proposed task planner model (GTTP) has the very high performance in terms of adaptability to the real-world environment.

The apparatuses described herein may be implemented using hardware components, software components, and/or combination of the hardware components and the software components. For example, the apparatuses and components described herein may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. A processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied in any type of machine, component, physical equipment, virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable storage mediums.

The methods according to example embodiments may be configured in a form of program instructions performed through various computer methods and recorded in non-transitory computer-readable media. The media may include, alone or in combination with program instructions, data files and data structures. The program instructions recorded in the media may be specially designed and configured for the example embodiments or may be known and available to those skilled in the computer software art. Examples of the media may include magnetic media such as hard disks, floppy disks, and magnetic tapes; optical media such as CD-ROM and DVDs; magneto-optical media such as floptical disks; and hardware devices that are specially configured to store and perform program instructions, such as ROM, RAM, flash memory, and the like. Examples of the program instructions include machine language codes as produced by a compiler and advanced language codes executable by a computer using an interpreter.

Although the example embodiments are described with reference to some specific example embodiments and accompanying drawings, it will be apparent to one of ordinary skill in the art that various alterations and modifications in form and details may be made in these example embodiments without departing from the spirit and scope of the claims and their equivalents. For example, suitable results may be achieved if the described techniques are performed in different order, and/or if components in a described system, architecture, device, or circuit are combined in a different manner, and/or replaced or supplemented by other components or their equivalents.

Therefore, other implementations, other example embodiments, and equivalents of the claims are to be construed as being included in the claims.

What is claimed is:

1. A task planning method performed by a task planning system, the task planning method comprising:
constructing a task planner model based on a graph neural network and a transformer; and
generating a task plan from a goal instruction of a task and history information of a scene graph through the constructed task planner model.

2. The task planning method of claim 1, wherein the generating comprises transforming a node and an edge constituting the scene graph to a node feature and an edge feature, respectively, through a scene graph encoder.

3. The task planning method of claim 1, wherein the generating comprises extracting an instruction feature that includes a sentence embedding and a token embedding from the goal instruction through an instruction encoder.

4. The task planning method of claim 1, wherein the generating comprises planning a subgoal based on context information of an ongoing task, based on history of a state graph encoded through a scene graph encoder and an instruction feature encoded through an instruction encoder in a subgoal planning network, and
the subgoal planning network includes a graph feature extractor and a subgoal predictor.

5. The task planning method of claim 4, wherein the generating comprises extracting a task-relevant feature from the history of the encoded state graph and the goal instruction using an edge update function, a node update function, and a global update function in a GNN layer stack.

6. The task planning method of claim 5, wherein:
the edge update function updates edge information by combining an edge that concatenates an i^{th} node and a j^{th} node and a sentence embedding and then passing through a multi-layer perceptron (MLP) function,
the node update function updates node information based on an i^{th} node feature and an edge feature and a sentence embedding with neighboring nodes updated from a previous edge update function, and
the global update function updates a node feature and a sentence embedding.

7. The task planning method of claim 5, wherein the generating comprises updating graph information using a node feature and a sentence embedding updated through cross-attention to emphasize a feature of an object having high goal relevance, and outputting a graph token from an initial time to a current time step through the updated graph information.

8. The task planning method of claim 7, wherein the generating comprises generating a state token for the output graph token and token embedding through cross-attention to emphasize a word having the highest relevance from an instruction in the current time step.

9. The task planning method of claim 8, wherein the generating comprises selecting a subgoal that includes action information and a target object in a next time step from the generated state token and the updated node feature.

10. The task planning method of claim 9, wherein the generating comprises generating a task token that encodes history information of an ongoing task through element-wise addition of the generated state token and a positional embedding in a task encoder, and generating a next action probability distribution and a next target object action distribution in a next time step from the generated state token and the updated node feature through an action decoder and an object decoder.

11. The task planning method of claim 10, wherein the generating comprises determining a feasible subgoal with the highest probability based on the generated next action probability distribution and next target object action distribution.

12. The task planning method of claim 9, wherein the generating comprises determining the feasibility of the selected subgoal that includes action information and the target object in the next time step according to a predefined rule for each action.

13. The task planning method of claim 1, wherein a node dropout method in which a specific object and background objects are categorized from an initial graph and a ground truth task plan is applied in a learning process of the task planner model.

14. A non-transitory computer-readable recording medium storing a computer program to execute a task planning method performed by a task planning system, wherein the task planning method comprises:
constructing a task planner model based on a graph neural network and a transformer; and
generating a task plan from a goal instruction of a task and history information of a scene graph through the constructed task planner model.

15. A task planning system comprising:
a model construction unit configured to construct a task planner model based on a graph neural network and a transformer; and
a task plan generation unit configured to generate a task plan from a goal instruction of a task and history information of a scene graph through the constructed task planner model.
